(19) United States
(12) Patent Application Publication
(10) Pub. No.: US 2020/0396895 A1
(43) Pub. Date: Dec. 24, 2020

(54) Marine Grass Seed Planting Method

(71) Applicant: Robert Vasiluth, Commack, NY (US)

(72) Inventor: Robert Vasiluth, Commack, NY (US)

(21) Appl. No.: 16/446,884

(22) Filed: Jun. 20, 2019

(51) Int. Cl. A01C 7/00; A01K 61/50

(52) U.S. Cl. CPC A01C 7/002; A01K 61/50; A01C 7/008

(57) ABSTRACT

A method for planting marine grass seed via a seed assembly comprising the steps of: selecting a body of water and area suitable for eele grass and shellfish, wherein the body of water has a bottom wherein shellfish can sufficiently bury themselves; selecting a living shellfish; placing a drop of non-toxic biodegradable adhesive on the shell of the living shellfish; positioning a grass seed to touch adhesive; waiting a predetermined time period for the adhesive to cure; and deploying the seed assembly into the body of water, wherein the seed assembly comprises the living shellfish, the drop of adhesive, and the positioned grass seed, wherein the body of water has a bottom where the shellfish can bury themselves sufficiently to bury the grass seed.

### BACKGROUND OF THE INVENTION

This invention relates to providing a method for planting marine grass seed, more particularly, providing a method of planting eel grass seed.

### PRIOR ART

There is a longstanding need in the industry to reduce the time needed to plant eel grass seed, improving the re-germination rate of the plantings, while reducing the costs of such planting, and reducing if not eliminating the negative environmental impact of the prior arts. However, the existing systems and methods fail to address these issues unlike the current invention set forth hereinbelow.

For example, traditional methods employ two scenarios. A first approach includes broadcasting seeds into the water, however, the downside is such that one needs to seriously overseed to have any effect, largely due to foraging species that feed on the eel grass seed while the seeds float in the water. A second approach is via the use of divers that either plant the seeds themselves, or they transplant seedlings, nonetheless in either case, the utilization of divers is time consuming, very expensive, and at times dangerous.

### SUMMARY OF INVENTION

An objective of the present invention includes providing a method to plant eel grass seed.

Another objective of the present invention includes providing a method to plant eel grass seed that reduces the cost and time of production.

A still further objective of the present invention includes providing a method to plant eel grass seed that improves the yield of plantings.

An additional objective of the present invention includes providing a method that reduces the negative impact on the environment.

Other objectives, advantages, and novel features of the present invention will become more apparent from the following detailed description when taken in conjunction with the accompanying drawings.

### BRIEF DESCRIPTION OF THE DRAWINGS

The following drawings, in which like reference characters indicate like parts, are provided for illustration of the invention and are not intended to limit the invention in any manner whatsoever.

FIG. 1 illustrates a flowchart of the preferred embodiment of the present invention;

and

FIG. 2 illustrates a flowchart of another preferred embodiment of the present invention;

FIG. 3 illustrates a flowchart of another preferred embodiment of the present invention; and

FIG. 4 illustrates the time lapse imagery of when a seed assembly lands at the bottom of a body of water up and until the seed germinates and grows the marine grass.

### DETAILED DESCRIPTION OF INVENTION

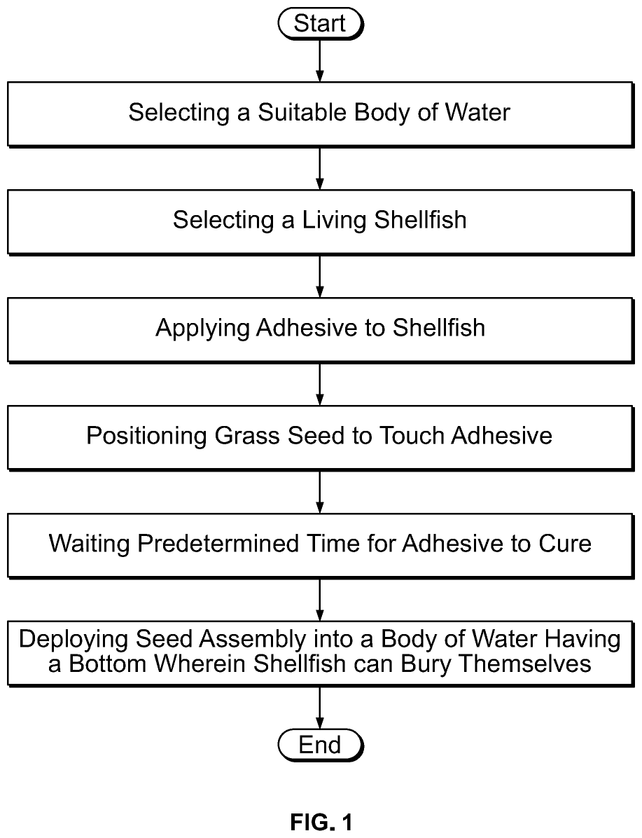

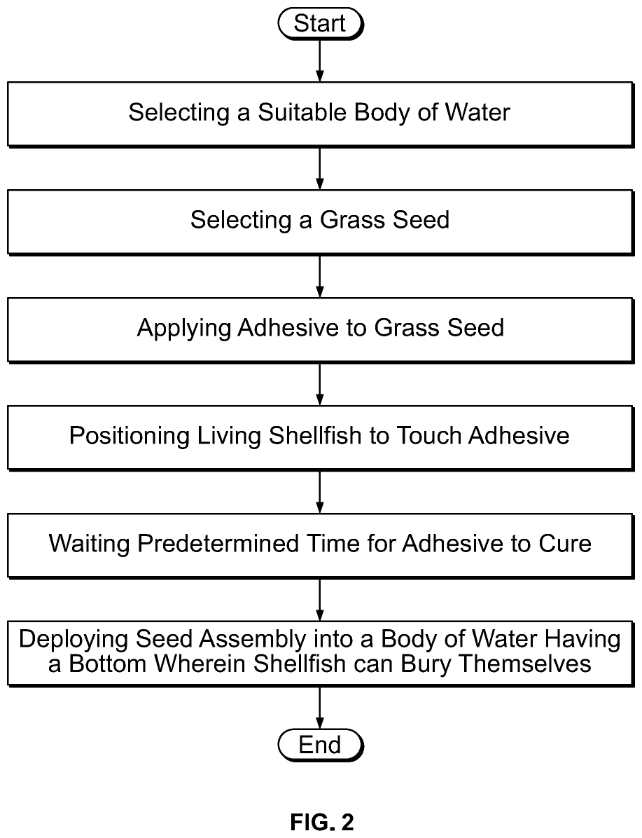

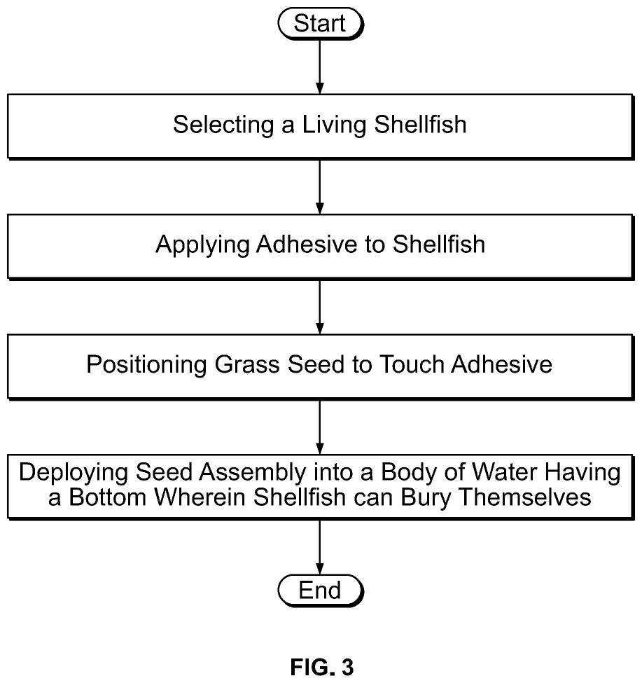

Referring generally to FIGS. 1 to 3, and Illustration A herein below, these illustrate method(s) of marine grass seed planting, namely, a method to plant eel grass utilizing a shellfish, more particularly, a clam.

An area of planting is determined where the planting of eel grass is desired, whether it is to be a newly seeded area or whether it is to be over seeded to increase the density of grass in a target area, or both. In particular, the body of water should include water viable for eelgrass to grow, and the sea bed of body of water should have soil, sand, etc., wherein the shellfish can sufficiently bury themselves therein, and hence the eel grass seed(s).

Clams are collected, inspected, and selected for the desired size, and quantity thereof, and staged. It should be noted that other types of living organisms may be substituted for the clams, which includes, but is not limited to oysters, mussels, razor claims including the fresh water type.

Eel grass seed is selected, prepared, and staged.

A non-toxic biodegradable adhesive is selected, and staged, e.g., glue manufactured and sold by CryoLife. In the instant application, the Applicant has used coral reef glue. Once these three items are staged, e.g., clams, seed, and adhesive, assembly may begin.

First, a living clam is selected to attach a seed thereto.

Second, a drop of biodegradable adhesive is strategically placed on the shell of the living clam. Typically, about the middle of a half shell, although any place would do.

Third, an eel grass seed is positioned to touch the drop of adhesive and held for a predetermined time allowing for curing thereof. In this particular case, about 20 seconds+/−10 seconds.

Fourth, once the adhesive and seed are cured, then the seed assembly of the clam, the adhesive, and seed is deployed into the water. Note, the assembly can be dropped in to the water from a vessel, and does not require a diver to swim to the bottom of the body of water, and physically plant the assembly. The beauty of present invention's method is that for a given area of sea floor (aka creek, stream, river, pond, lake, ocean etc.), more seeds can be placed more quickly at less cost. Moreover, the synergy between the clam and the seed are astonishing. As the assembly falls to the bottom of the water and comes to rest on the sea bed, the living clam will, with the grass seed attached to it's shell, bury itself into the sand, thereby planting the seed. Moreover, the clam will release nitrogen via their excrement throughout the clam's lifecycle that will be utilized by the eel grass to grow, in a point of use scenario. The present invention's method avoids the issue of excessive nitrogen discharge into the waters utilized by other methods that cloud the waters, while here it also provides sufficiently continuous nitrogen supply for the eel grass seed. Furthermore, the shellfish clear the water of marine organisms that block much needed sunlight for the eel grass. Eventually, once the grass seed begins to grow, and some point it will separate from the shellfish and take root in the sea bed.

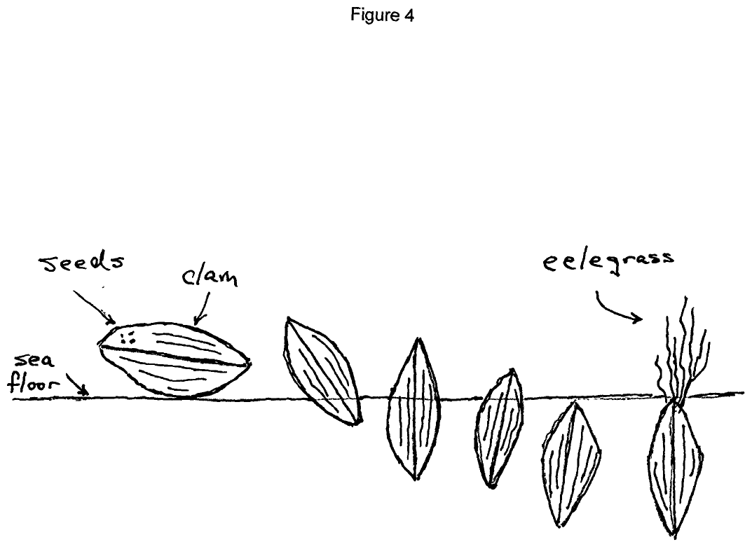

The method is depicted in FIG. 4, wherein a preferred embodiment of the present invention, setting narrating the time lapse imagery of when a seed assembly lands at the bottom of a body of water up and until the seed germinates and grows the marine grass. It should be noted, the depth of seed in sentiment is determined by size of the shellfish, and the attachment area of the seed.

All the above referenced patents; patent applications and publications are hereby incorporated by reference. Having thus described a few particular embodiments of the invention, various alterations, modifications, and improvements will readily occur to those skilled in the art. Such alterations, modifications and improvements as are made obvious by this disclosure are intended to be part of this description though not expressly stated herein, and are intended to be within the spirit and scope of the invention. Accordingly, the foregoing description is by way of example only, and is not limiting. The invention is limited only as defined in the claims and equivalents thereto.

1. A method for planting marine grass seed via a seed assembly comprising the steps of:
a. Selecting a body of water and area suitable for eele grass and shellfish, wherein said body of water has a bottom wherein shellfish can sufficiently bury themselves;
b. Selecting a living shellfish;
c. Placing a drop of non-toxic biodegradable adhesive on the shell of the living shellfish;
d. Positioning a grass seed to touch adhesive;
e. Waiting a predetermined time period for the adhesive to cure; and
f. Deploying the seed assembly into the body of water, wherein said seed assembly comprises said living shellfish, said drop of adhesive, and said positioned grass seed, wherein the body of water has a bottom where the shellfish can bury themselves sufficiently to bury said grass seed.

2. A method for planting marine grass seed via a seed assembly comprising the steps of:
a. Selecting a body of water and area suitable for eele grass and shellfish, wherein said body of water has a bottom wherein shellfish can sufficiently bury themselves;
b. Selecting a grass seed;
c. Placing a drop of non-toxic biodegradable adhesive on the grass seed;
d. Positioning a living shellfish to touch adhesive;
e. Waiting a predetermined time period for the adhesive to cure; and
f. Deploying the seed assembly into the body of water, wherein said seed assembly comprises said living shellfish, said drop of adhesive, and said positioned grass seed, wherein the body of water has a bottom where the shellfish can bury themselves sufficiently to bury said grass seed.

3. A method for planting marine grass seed via a seed assembly comprising the steps of:
a. Selecting a living shellfish;
b. placing a drop of non-toxic biodegradable adhesive on the shellfish;
c. positioning a grass seed to touch adhesive; and
d. deploying the seed assembly into a body of water.

4. A method as in claim 3, further comprising the step of selecting a body of water and area suitable for eele grass and shellfish, wherein said body of water has a bottom wherein shellfish can sufficiently bury themselves.

5. A method as in claim 3, further comprising the step of waiting a predetermined time period for the adhesive to cure.

6. A method as in claim 3, wherein deploying the seed assembly further includes wherein the body of water has a bottom where the shellfish can bury themselves sufficiently to bury said grass seed.
